(19) United States
(12) Patent Application Publication
(10) Pub. No.: US 2002/0163535 A1
(43) Pub. Date: Nov. 7, 2002

(54) System and method for generating a graphical user interface from a template

(76) Inventors: Kathryn L. Mitchell, Corvallis, OR (US); John M. Kerr, Monmouth, OR (US); Steven P. Hiebert, Corvallis, OR (US); Richard N. McKay, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 09/735,025

(22) Filed: Dec. 11, 2000

(51) Int. Cl. G06F 3/00; G09G 5/00

(52) U.S. Cl. 345/744; 345/746; 345/762

(57) ABSTRACT

Various systems and methods are described for generating a graphical user interface (GUI) from a template. In one embodiment, a system is provided that comprises a processor circuit having a processor and a memory. Stored on the memory and executable by the processor is GUI generation logic. The GUI generation logic includes logic to generate an input field in the graphical user interface that is associated with an input item in a template. The GUI generation logic also includes logic to generate an input field label in the graphical user interface from an input field tag in the template, wherein the input field tag is associated with the input item.

### TECHNICAL FIELD

The present invention is generally related to the field of on-line printing and, more particularly, is related to a system and method for generating a graphical user interface from a template used to obtain input information relative to a document to be printed.

### BACKGROUND OF THE INVENTION

In the mid 1400's, Johann Gutenburg revolutionized how information is disseminated through his invention of the movable type press. With the publication of the Mazarin Bible, documents that were once held in the exclusive domain of a chosen few were now widely available to the masses. Nearly 550 years later, the mass media revolution that Gutenburg started is alive and well, complete with newspapers such as the New York Times and the Washington Post, magazines such as Newsweek and Sports Illustrated, and literally thousands upon thousands of other lesser known publications.

In addition, many print shops currently exist that provide printing services to individuals. Specifically, such print shops may make copies of printed matter for an individual for a specific use. For example, an individual may wish to print a number of flyers to be posted in their neighborhood in search of a lost pet. Others may wish to create sales literature or a restaurant may wish to create menus for its patrons. In the typical case, an individual or business employs such services as needed, necessitating a trip to the print shop in question.

However, current printer technology has evolved to allow users to print documents of professional quality using a personal computer. Consequently, rather than visit a local print shop to generate printed matter, it is possible that the same printed matter may be created on-line in digital form through the Internet or equivalent network. Specifically, a user may access an on-line printing service and configure the digital document that is downloaded, for example, to their personal computer. Thereafter, the document may be printed, for example, on a printer attached to the personal computer.

In order to create the digital document using this approach, it is necessary that a user input the information that forms part of the document. For common documents that have a similar format, standardized templates may be employed that require a user to input the document specific information necessary to create the desired digital document. Unfortunately, given that there may be a multitude of potential templates for various types of common documents, a corresponding number of input interfaces are required with which to harvest the document specific information from a user to create the corresponding digital documents. The time and expense incurred to create these input interfaces represents a significant obstacle to the progress of on-line publishing.

### SUMMARY OF THE INVENTION

In light of the forgoing, the present invention provides for various systems and methods for generating a graphical user interface (GUI) from a template. In one embodiment, a system is provided that comprises a processor circuit having a processor and a memory. Stored on the memory and executable by the processor is GUI generation logic. The GUI generation logic includes logic to generate an input field in the graphical user interface that is associated with an input item in a template. The GUI generation logic also includes logic to generate an input field label in the graphical user interface from an input field tag in the template, wherein the input field tag is associated with the input item.

The present invention may also be viewed as a method for generating a graphical user interface. The present method comprising the steps of: generating an input field in a graphical user interface in a server, where the input field is associated with an input item in a template that is stored in the server; and generating an input field label in a graphical user interface from an input field tag in the template, the input field tag being associated with the input item in the template.

The present invention also provides for a second system for generating a graphical user interface (GUI). This second system comprises a processor circuit within a server, for example, that includes a processor and a memory. Stored on the memory and executable by the processor is GUI generation logic. The GUI generation logic includes logic to identify an input item with a default value in a template, where the template represents a document. The GUI generation logic also includes logic to generate the graphical user interface from the template that displays the document with an input field included therein, wherein the input field is associated with the input item. The document is displayed in a “what you see is what you get” (WYSIWYG) format to enable a user to see the ultimate document created.

In addition, the present invention provides for a method for generating a graphical user interface, comprising the steps of: identifying an input item with a default value in a template stored in a server, the template representing a document; and generating the graphical user interface in the server from the template that displays the document with an input field included therein, wherein the input field is associated with the input item.

Other features and advantages of the present invention will become apparent to a person with ordinary skill in the art in view of the following drawings and detailed description. It is intended that all such additional features and advantages be included herein within the scope of the present invention.

### BRIEF DESCRIPTION OF THE SEVERAL VIEWS OF THE DRAWINGS

The invention can be understood with reference to the following drawings. The components in the drawings are not necessarily to scale. Also, in the drawings, like reference numerals designate corresponding parts throughout the several views.

FIG. 1 is a block diagram of a network that includes a server with graphical user interface (GUI) generation logic according to an embodiment of the present invention;

FIG. 2 is a drawing of a first template that is stored in a template database in the server of FIG. 1;

FIG. 3 is a drawing of a first graphical user interface generated by the GUI generation logic of FIG. 1 based upon the first template of FIG. 2;

FIG. 4 is a flow chart of a first version of the GUT generation logic in the server of FIG. 1;

FIG. 5 is a flow chart further depicting the first version of the GUI generation logic in the server of FIG. 1;

FIG. 6 is a drawing of a second template that is stored in a template database in the server of FIG. 1;

FIG. 7 is a drawing of a second graphical user interface generated by the GUI generation logic of FIG. 1 based upon the second template of FIG. 6; and

FIG. 8 is a flow chart of a second version of the GUI generation logic in the server of FIG. 1.

### DETAILED DESCRIPTION OF THE INVENTION

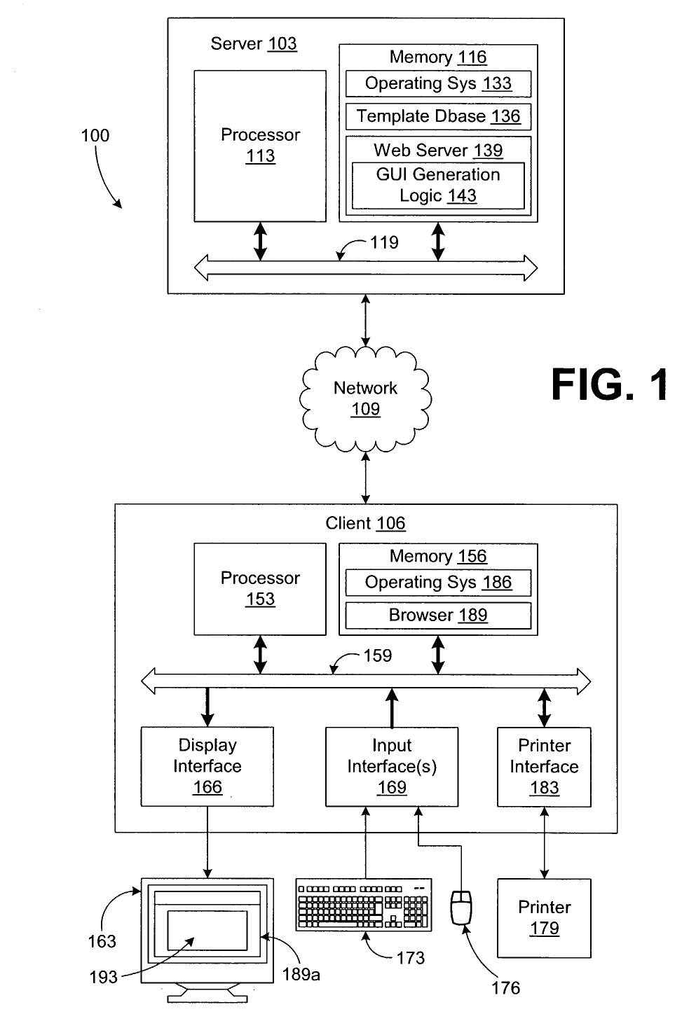

Turning to FIG. 1, shown is an information exchange network 100 according to the present invention. Before discussing the operation of the information exchange network 100, first a description of the physical aspects of the information exchange network 100 is provided.

The information exchange network 100 includes a server 103 and a client 106, both of which are linked to a network 109. The server 103 and the client 106 may be, for example, computer systems or other such devices. In this regard, the server 103 includes a processor 113 and a memory 116, both of which are coupled to a local interface 119. The local interface 119 may be, for example, a data bus with an accompanying control bus as is generally known by those with ordinary skill in the art. Stored on the memory 116 and executable by the processor 113 is an operating system 133, a template database 136, a web server 139, and graphical user interface (GUI) generation logic 143 that is executed as part of the web server 139, as will be discussed.

The client 106 also includes a processor 153 and a memory 156, both of which are coupled to a local interface 159. The local interface 159 may be, for example, a data bus with an accompanying control bus as is generally known by those with ordinary skill in the art. The client 106 features a display device 163 that is coupled to the local interface 159 through a display interface 166. The display device 163 may be, for example, a cathode ray tube (CRT), a liquid crystal display screen, a gas plasma-based flat panel display, indicator lights, light emitting diodes, or other suitable display device. The display interface 166 may be, for example, an appropriate video card or other such device.

The client 106 includes one or more input interfaces 169 that couple a keyboard 173 and a mouse 176 to the local interface 159. The input interfaces 169 may be, for example, appropriate interface cards or other interfaces. The client 106 also features a printer 179 that is coupled to the local interface 159 via a printer interface 183. The printer interface 183 may be, for example, an appropriate printer card or other such device that provides a printer port access to the client 106. In addition, the client device 106 may include other peripheral devices, such as, for example, a keypad, touch pad, touch screen, microphone, scanner, joystick, or one or more push buttons, etc. User output devices may include indicator lights, speakers, etc.

The client 106 also includes an operating system 183 and a browser 186, both of which are stored on the memory 156 and executable by the processor 153. Also stored on the memory 156 and executable by the processor 153 is a page layout engine (not shown). The page layout engine is executed to generate a digital document from a template as will be discussed. The browser 186 generates a graphical browser 189a that is displayed on the display device 163. Displayed within the graphical browser 189a may be, for example, various graphical user interfaces 193 that are manipulated by the user using, for example, the keyboard 173 and the mouse 176. In addition, the client 106 may include, for example, appropriate drivers (not shown) that are stored on the memory 156 and are executable by the processor 153. The drivers may be executed to facilitate communication with the display device 163, keyboard 173, mouse 176, and the printer 179 as well as other peripheral devices not described herein but are generally known by those who possess ordinary skill in the art.

The memories 116 and 156 may include both volatile and nonvolatile memory components. Volatile components are those that do not retain data values upon loss of power. Nonvolatile components are those that retain data upon a loss of power. Thus, the memories 116 and 156 may comprise, for example, random access memory (RAM), read-only memory (ROM), hard disk drives, floppy disks accessed via an associated floppy disk drive, compact disks accessed via a compact disk drive, magnetic tapes accessed via an appropriate tape drive, and/or other memory components, or a combination of any two or more of these memory components. The memories 116 and 156 may comprise, electrical, optical, and magnetic technologies as well as other interchangeable memory technologies.

In addition, each of the processors 113 and 153 may represent multiple processors and each of the memories 116 and 156 may represent multiple memories that operate in parallel. In such a case, the local interfaces 119 and 159 may be an appropriate network that facilitates communication between any two of the multiple processors or between any processor and any of the memories, etc. The local interfaces 119 and 159 may facilitate memory to memory communication as well. The processors 113/153 and local interfaces 119/159 may employ electrical and/or optical technologies or other interchangeable technologies.

The network 109 includes, for example, the Internet, wide area networks (WANs), local area networks, or other suitable networks, etc., or any combination of two or more such networks. The server 103 and the client 106 are coupled to the network 109 to facilitate data communication to and from the network 109 in any one of a number of ways that are generally known by those of ordinary skill in the art. The server 103 and the client 106 may be linked to the network 109 through various devices such as, for example, network cards, modems, or other such communications devices.

Next, an overview of the operation of the information exchange network 100 is provided. To begin, a user of the client 106 wishes to publish a document. For example, a particular user may wish to create flyers to promote a specific interest by posting in various locations. In such a case, the user needs to create the flyer in question and print out multiple copies for posting. To do this, a user employs the browser 186 in the client 106 to access the web server 139 through the network 109. The web server 139 provides the capability of generating the document that the user wishes to create in digital form. However, the specific information to be included in the flyer must be provided to the web server 139 by the user through the browser 186 in the client 106. The GUI generation logic 143 is executed in the server 103 to provide various graphical user interfaces 179 that are transmitted to the client 106 and displayed using the browser 186 that allow the user to enter the flyer specific information. Ultimately, by entering the flyer specific information using the graphical user interface 193, the user provides the information to the web server 139 that is necessary to create the document in digital form that is ultimately sent to the client 106.

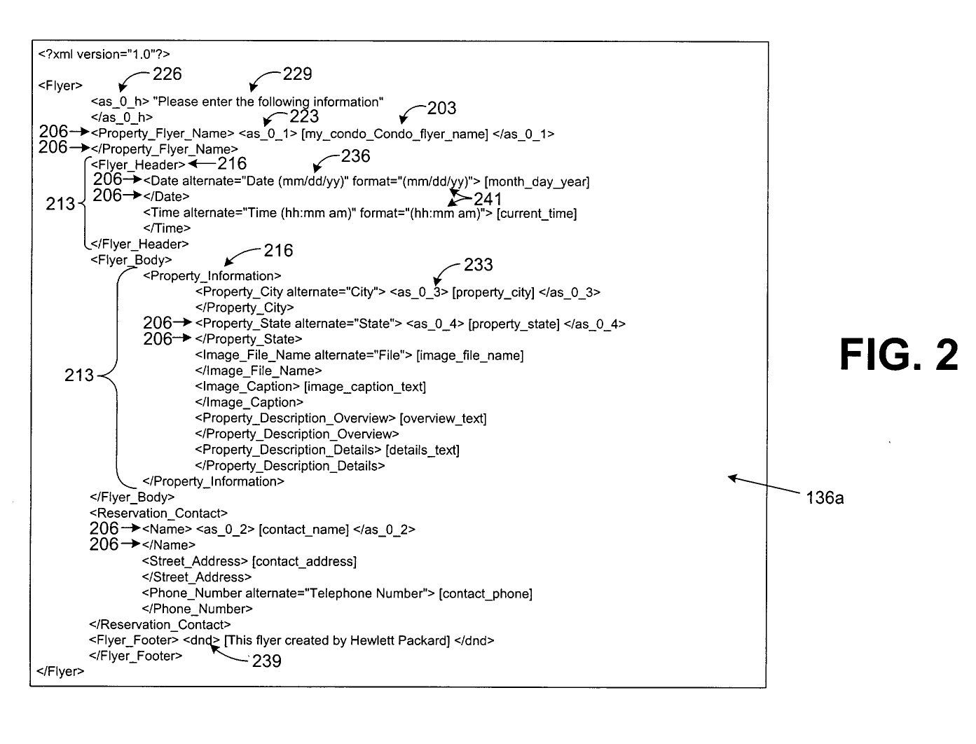

With reference to FIG. 2, shown is a first template 136a that is stored within the template database 136 (FIG. 1) according to an aspect of the present invention. The first template 136a is representative of a multitude of templates stored in the template database 136. The first template 136a may be generated using, for example, extensible mark-up language (XML) or other language as is generally known by those with ordinary skill in the art. The first template 136a provides specific tags and information that allow the GUI generation logic 143 (FIG. 1) to generate the graphical user interfaces 193 (FIG. 1) that are transmitted to the client 106 (FIG. 1) and displayed on the display device 163 (FIG. 1). In this regard, the template 136a includes a number of input items 203 that are enclosed in brackets throughout the first template 136a. Each input item 203 is identified by a set of input field tags 206. Note that each type of tag as discussed herein includes the related initial and ending tags as set forth by the dictates of XML as is generally know by those with ordinary skill in the art. However, it is understood that other markup languages may also be employed beyond XML.

The input items 203 contain information that is included in the digital document from the first template 136a. When a digital document is to be created, the first template 136a is created as an instance of an identical template stored in the template database 136 and placed in the memory 116, such as, for example, random access memory. The first template 136a is organized in sections 213. Each section may be identified, for example, by section tags 216. A section 213 may be defined as having section tags 216 with a number of nested input items 203 as identified by the input field tags 206. Alternatively, a single input item 203 may act as its own section 213, as is the case with the “Property_Flyer_Name” in the first template 136a.

Input items 203 are not nested, for example, within any other input item 203 in a given section 213. By organizing the first template 136a into the sections 213 that group the input items 203 according to some criteria, it is possible to determine the nature of the information that is to be placed in the various input items 203 by examining the section tags 216.

The sections 213 are shown as contiguous sections with no separation of the input items 203 nested therein. However, the first template 136a may also include alternate sections that comprise a number of input items 203 from various different points in the first template 136a. An alternate section employs alternate section tags 223 that are associated with various input items 203 to indicate whether the respective input items 203 are part of an alternate section. There may be multiple alternate sections within a given first template 136a. Therefore, the alternate section tags 223 include an alternate section number. For example, for an alternate section tag “as_{—}0_{—}3”, the “0” indicates the alternate section number. The alternate section numbers that indicate separate alternate sections may be a number such as, for example, “0, 1, 2, . . . ” or characters such as “a, b, c, . . .,” etc. in a similar manner to the “0” in the above example. In this manner, all of the input items 203 that belong to a particular alternate section include an alternate section tag 223 with an identical alternate section number or other character in the above identified position in the alternate section tag 223.

To provide a heading for the alternate section, an alternate section heading tag 226 is included that indicates the alternate section heading 229. In addition, the alternate section tags 223 also indicate an alternate section priority 233 with a number that falls at the end of the alternate section tag 223. The alternate section priority 233 indicates a priority for the particular input item 203 within the alternate section relative to the other input items 203 in the same alternate section. This priority may be employed, for example, to determine the order in which the input items 203 are displayed in a graphical user interface 193. The first template 136a also includes alternate label attributes 236 that provide label information that is displayed in the graphical user interface 193 instead of the text contained within the input field tags 206 as will be discussed. Alternatively, the same label information could be implemented as separate tags rather than within the context of an attribute. As discussed herein, the alternate label attributes 236 include the use of separate tags as such.

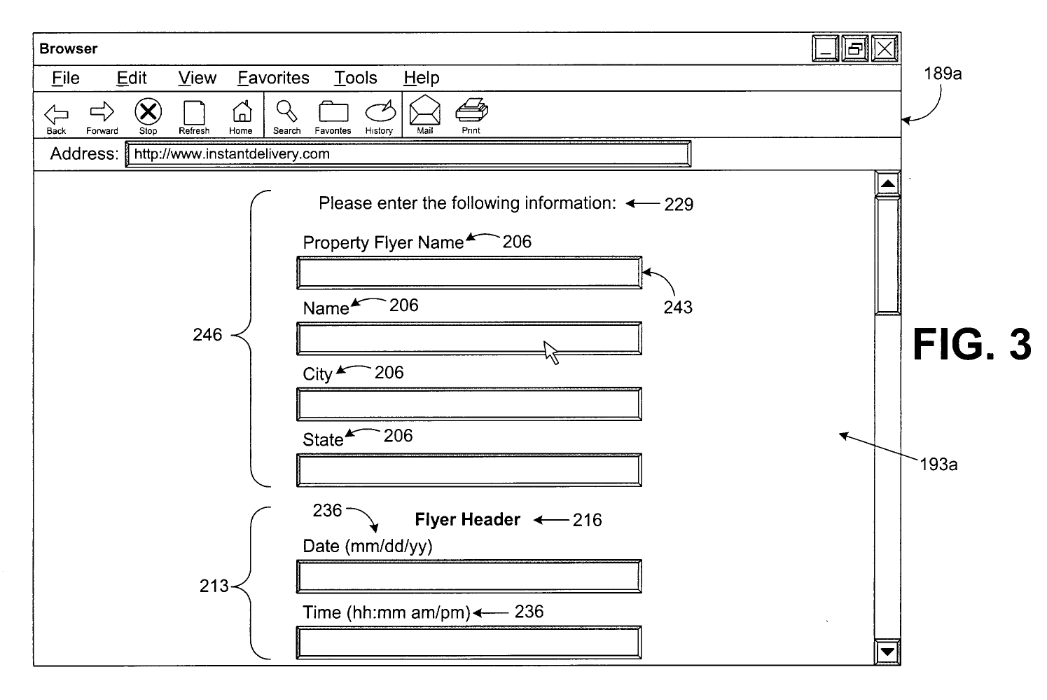

In addition, the first template 136a includes “do not display” tags 239 that indicate to the GUI generation logic 143 that the input item 203 associated with the “do not display” tag 239 is not to be displayed in the graphical user interface 193. The first template 136a also features “format” attributes 241 that may be associated with the input items 203. The format attributes 241 indicate the specific format of the data that is to be included in their associated input item 203. A data format may be, for example, a date which may be in the form “mm/dd/yy” or telephone numbers that are in the form “(nnn) nnn-nnnn”, etc. All of the various tags in the first template 136a are employed by the GUI generation logic 143 to generate the graphical user interface 193 (FIG. 1) as will be discussed with reference to FIG. 3.

With reference to FIG. 3, shown is a first graphical user interface 193a according to an aspect of the present invention. The graphical user interface 193a includes a number of input fields 243. Each of the input fields 243 corresponds to a respective input item 203 (FIG. 2) in the first template 136a (FIG. 2). The input fields 243 are organized in terms of an alternate section 246 and a section 213 as shown. Note the first graphical user interface 193a may be scrolled down to reveal further sections 246/213.

The alternate section 246 includes an alternate section heading 229 at the top. Each of the input fields 243 is labeled with a corresponding input field tag 206. That is to say, the input fields 243 are labeled with text taken from the input field tags 206. The label for the section 213 is generated from a section tag 216. The headings above each of the input fields 243 in the section 213 is generated from respective alternate label attributes 236 of the first template 136a. This is because the alternate label attributes 236 are associated with the respective input items 203 for which the input fields 243 are generated in the first graphical user interface 193a. The alternate label attributes 236 are employed to label the respective input fields 243 of the section 213 as the input field tags 206 for the corresponding input items 203 are deemed inadequate to label the input fields 243 in the first graphical user interface 136a.

Thus, the first graphical user interface 136a is generated by the GUI generation logic 143 by parsing through the first template 136a to find the appropriate sections, section headings, and tags to label the various input fields 243. Note that any underscores included in the tags employed as labels herein are ignored and displayed as a single blank space. Consequently, the present invention provides an advantage in that the first graphical user interface 193a may be generated directly from the first template 136a.

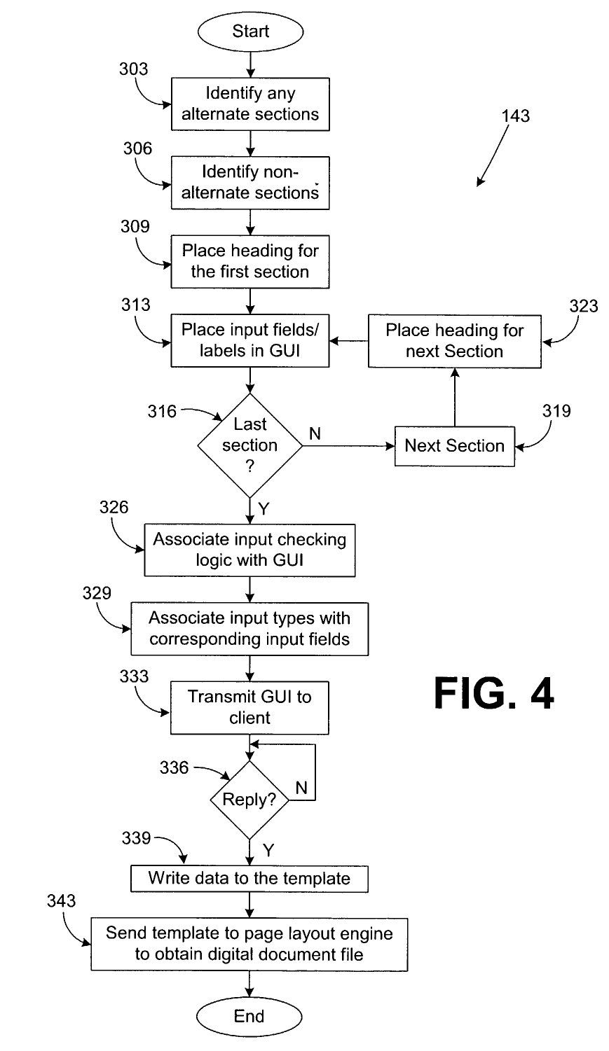

With reference to FIG. 4, shown is a flowchart of GUI generation logic 143a according to an embodiment of the present invention. The GUI generation logic 143a is executed in the server 103 (FIG. 1) to generate the first graphical user interface 193a (FIG. 3) from the first template 136a (FIG. 2). As a part of the web server 139 (FIG. 1), the GUI generation logic 143a is executed when a request with a URL is received from the client 106 (FIG. 1) that necessitates the creation of the graphical user interface 193a. This occurs in conjunction with the creation of a document by a user of the client 106 as was previously described. The following assumes that the first template 136a is chosen from a number of templates in the template database 136 to create a corresponding document.

Beginning with block 303, the GUI generation logic 143a identifies any alternate sections 246 within the first template 136a. This is done by identifying all of the alternate section tags 223 (FIG. 2) within the first template 136a. Thereafter, in block 306 all sections 213 (FIG. 2) that are not alternate sections 246 (FIG. 3) are identified. This is accomplished by identifying section tags 216 (FIG. 2) that include nested input items 203 (FIG. 2) or by identifying any input items 203 as identified by their associated input field tags 206 (FIG. 2) that are not nested within any section tags 216.

Then, in block 309 the first section 246/213 is identified for processing and the heading for that section is placed in the graphical user interface 193a. The section heading may be, for example, an alternate section heading 229 (FIG. 3) or the text contained within a section tag 216. Next, in block 313, an input field 243 (FIG. 3) is generated in the first GUI 193a for each of the input items 203 within the particular section 246/213. In addition, the appropriate input field tag 206 or alternate label attribute 236 (FIG. 2) is placed above each input field 243 as set forth by the first template 136a.

In block 316, it is determined whether the last section 246/213 in the template 136a has been represented in the first graphical user interface 193a. If not, then the GUI generation logic 143a moves to block 319 in which the next section 246/213 is identified. Thereafter, in block 323 the heading for the next section 246/213 identified in block 319 is included in the first graphical user interface 193a. Thereafter, the GUI generation logic 143a reverts back to block 313 to place the input fields 243 and their corresponding labels in the first graphical user interface 193a for the new section 246/213.

Referring back to block 316, assuming that the last section 246/213 has been placed in the first graphical user interface 193a, then the GUI generation logic 143a moves to block 326 in which input checking logic is associated with the first graphical user interface 193. The input checking logic may be implemented, for example, in the form of an applet or JAVA™ Script using computer languages as set forth by Sun Microsystems of Palo Alto, Calif. The input checking logic may be implemented using other programming languages as well. The input checking logic is transmitted with the first graphical user interface 193a and executed on the browser 189a as is known by those with ordinary skill in the art. The input checking logic is executed on the client 106 to ensure that information entered into input fields 243 conforms to any required data format as indicated by format attributes 241, if any, associated with the respective input items 203. For example, if a date is required, then the input checking logic will ensure that it is in the “mm/dd/yy” format. If entered incorrectly, the input checking logic will prompt the user to reenter the information.

Thereafter, the GUI generation logic 143a moves to block 329 in which the various format attributes 241 (FIG. 2) are associated with their corresponding input fields 243 (FIG. 3). This is done so that the input checking logic will know which input fields 243 must be checked and in what form they should be input.

Thereafter, the GUI generation logic 143a moves to block 333 in which the graphical user interface 193 (FIG. 1) is transmitted to the client 106. Then, in block 336, the GUI generation logic 143a waits for a reply from the client 106. After the reply is received, the GUI generation logic 143a moves to block 339 in which the data received from the client 106 in the reply is written into the first template 136a in the appropriate input items 203. Thereafter, the GUI generation logic 143a moves to block 343 in which the first template 136a is applied to a page layout engine. The page layout engine creates a digital document file from the first template 136a that may be downloaded to the client 106 for printing on the printer 179 (FIG. 1). The page layout engine is programmed to ignore the various tags employed solely to produce the graphical user interface 193a such as the alternate section tags 223, etc.

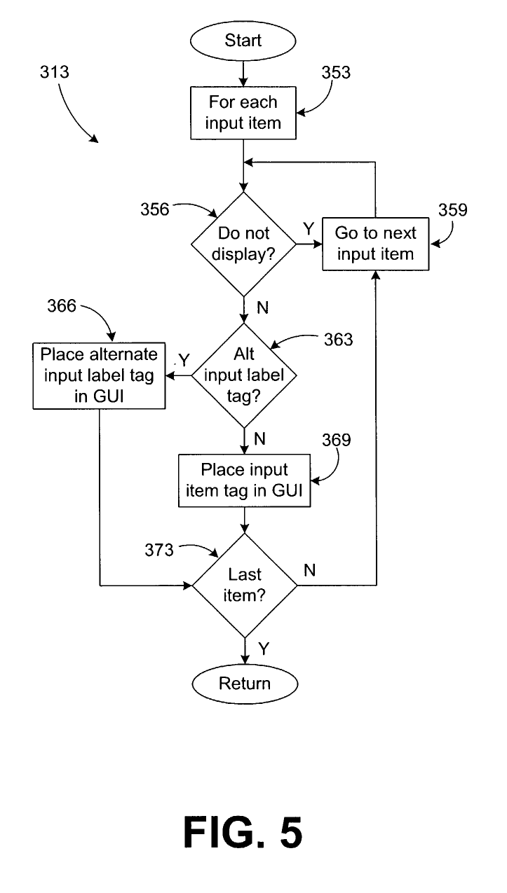

Referring then to FIG. 5, shown is a second flowchart that provides further detail of block 313 of the GUI generation logic 143a. Beginning with block 353, a loop is commenced for each input item 203 (FIG. 2) within the current section 246/213 (FIG. 3). The GUI generation logic 143a then moves to block 356 in which it is determined whether a “do not display” tag 239 (FIG. 2) is associated with the current input item 203 in question. If so, then the GUI generation logic 143a moves to block 359 in which the next input item 203 is identified and the loop continues as shown. This is because the input item 203 is effectively skipped over as it is not to be included in the graphical user interface 193a. However, if in block 356 there is no “do not display” tag 239 that is associated with the input item 203, then the GUI generation logic 143a moves to block 363.

In block 363, it is determined whether there is an alternate label attribute 236 (FIG. 2) associated with the current input item 203 in question. If so, then the GUI generation logic 143a moves to block 366 in which the alternate label attribute 236 is placed above the corresponding input field 243 (FIG. 3) in the first graphical user interface 193a. However, if in block 363 there is no alternate label attribute 236 associated with the current input item 203, then the GUI generation logic 143a moves to block 369. In block 369, the text of the input field tag 206 that is associated with the current input item 203 is placed as a label above the associated input field 243 in the first graphical user interface 193a. The GUI generation logic 143a moves from either block 366 or block 369 to block 373 in which it is determined whether the last input item 203 in the current section 246/213 has been processed. If not, then the GUI generation logic 143a reverts back to block 359 to address the next input item 203. Otherwise, the GUI generation logic 143a returns to block 316 (FIG. 4) as shown.

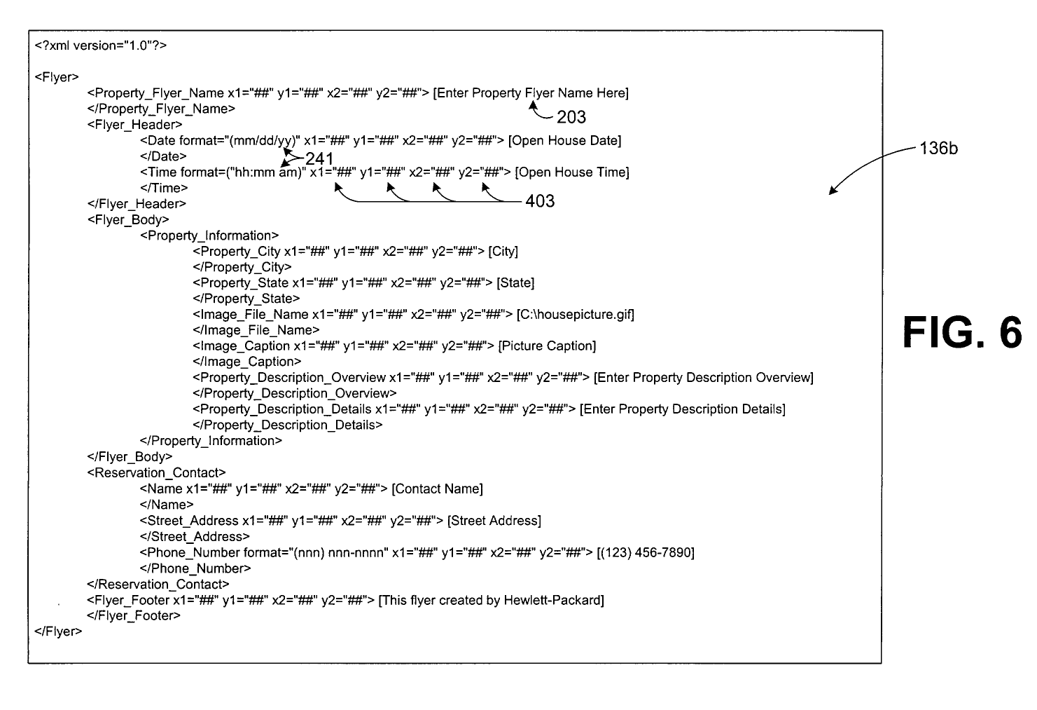

With reference to FIG. 6, shown is a second template 136b according to another aspect of the present invention. The second template 136b is stored in the template database 136 and accessed to create a specific document in similar fashion to the first template 136a.

The second template 136b includes the input items 203 and the format attributes 241 as it relates to specific input items 203. Associated with each input item 203 is location information 403 that identifies the coordinates at which the particular input item 203 is to appear on the final document that is to be produced. Note that the “#” symbols shown in location information 403 represent actual numbers that are to be included to locate the respective input item 203 in the final document produced. The second template 136b includes a number of default values within the input items 203. The location information 403 may be obtained, for example, by applying the second template 136b that is instantiated without such location 403 to a page layout engine or other such processing that inserts the location information 403 into the second template 136b. Alternatively, the second template 136b may be stored in the template database 136 with the location information 403.

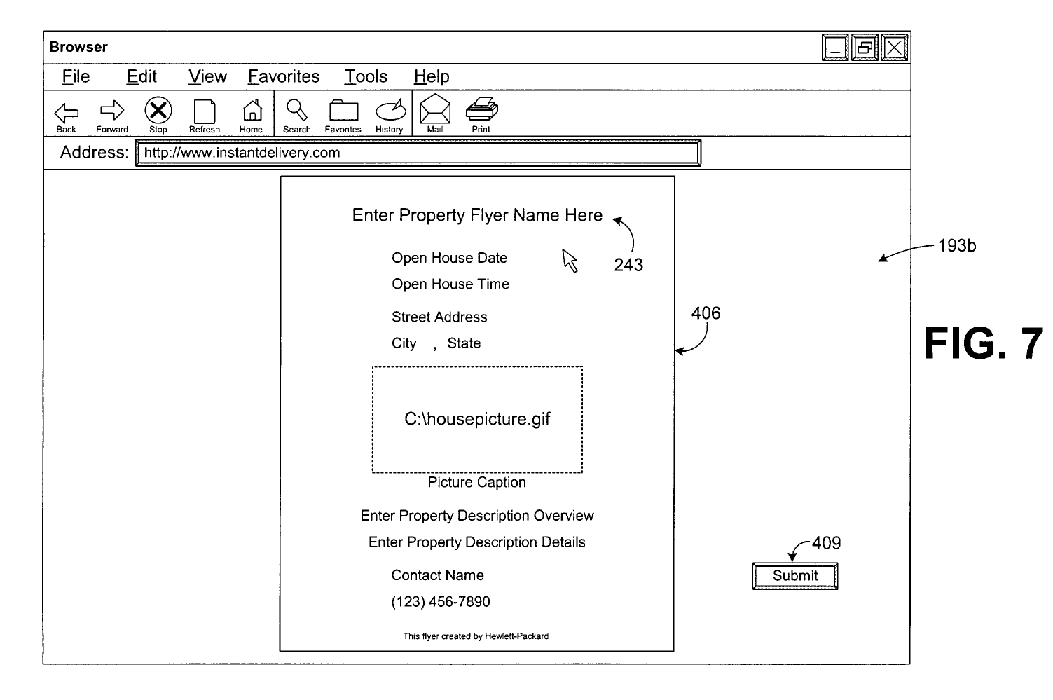

Turning then to FIG. 7, shown is the graphical browser 189a that shows a second graphical user interface 193b according to another aspect of the present invention. The second graphical user interface 193b is in a “what you see is what you get” format. Specifically, the second graphical user interface 193b appears the same as the final digital document that is created on the server 103 (FIG. 1) and downloaded to the client 106 (FIG. 1) for printing on the printer 179 (FIG. 1).

As shown, the second graphical user interface 193b includes a document 406 that shows a number of input fields 243 in the location that they would be normally be depicted in the final digital document that is created. The input fields 243 include the default value from the associated input item 203 (FIG. 6). To enter information, the user may click on one of the input fields 243 to highlight it. The user may then enter the appropriate information with a keyboard, for example, replacing the default value. The user may then click on the submit button 409 that causes the information that was entered to be transmitted to the server 103. This information is written into the second template 136b replacing the default values accordingly.

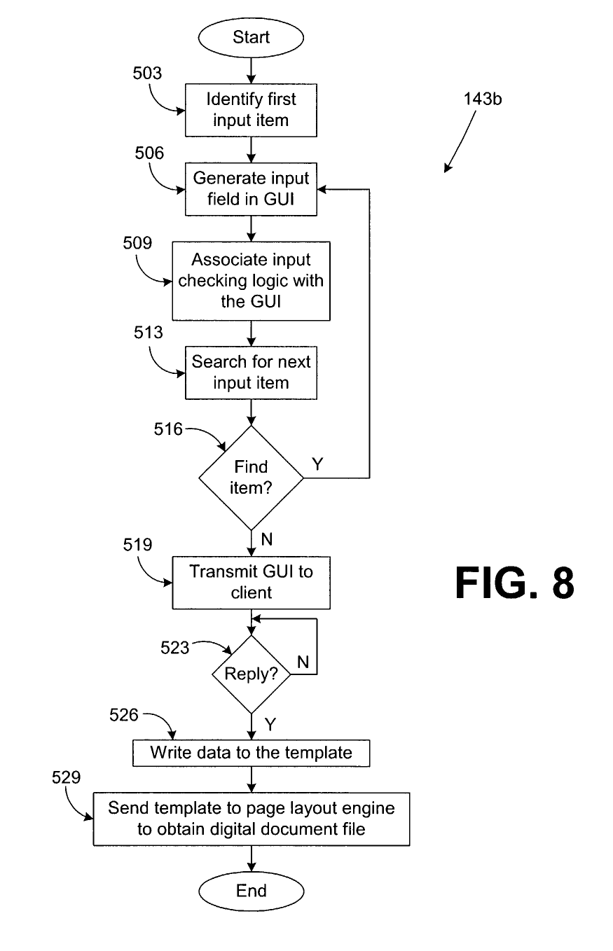

With reference to FIG. 8, shown is a flowchart of GUI generation logic 143b according to another embodiment of the present invention. The GUI generation logic 143b is advantageous in that it provides the “what you see is what you get” graphical user interface 193b (FIG. 7). The GUI generation logic 143b is executed when a particular request with a URL is supplied from the client 106 (FIG. 1) to the server 103 (FIG. 1) that requests the graphical user interface 193b.

The GUI generation logic 143 begins with block 503 in which the first input item 203 (FIG. 6) is identified that is to be included in the second graphical user interface 193b. Thereafter, in block 506, the input field 243 (FIG. 7) that corresponds to the input item 203 is generated in the second graphical user interface 193b. The input field 243 generated includes the default value of the input item 203. Next, in block 509, input checking logic is associated with the second graphical user interface 193b to provide an ability to check any erroneous formats entered by the user in a similar manner as was discussed with reference to the GUI generation logic 143a (FIG. 4).

Next, in block 513, the GUI generation logic 143b searches for the next input item 203 in the second template 136b. In block 516, if another input item 203 is found, then the GUI generation logic 143 reverts back to block 506. Otherwise, the GUI generation logic 143b progresses to block 519 as there are no further input items 203 in the second template 136b for which a respective input field 243 need be generated in the second graphical user interface 193b. In block 519, the second graphical user interface is transmitted to the client 106 (FIG. 1). Note that input checking logic may be associated with the second graphical user interface based on the format attributes 241 as was discussed with reference to FIG. 4. Alternatively, the input checking logic may not be associated therewith as the user may wish to vary the appearance of various input items 203 to suit their liking.

Thereafter, in block 523, the GUI generation logic 143 waits to receive a reply that includes the input information for each of the input items 203 from the client 106. Assuming that such is received, the GUI generation logic 143b moves to block 526 in which the data received is written into the input items 203 in the second template 136b over the default values. Thereafter, in block 529, the second template 136b is applied to a page layout engine or other processing logic to obtain the full digital document file that is thereafter downloaded to the client 106 for printing, for example, on the printer 179 (FIG. 1). The digital document file may also be depicted on the display device 163 or presented to the user using other media. Finally, after block 529, the GUI generation logic 143b ends accordingly.

The GUI generation logic 143b provides a distinct advantage in that the user may enter information into the particular document to be created in a “what you see is what you get” (WYSIWYG) format that allows the user to have a good idea of the appearance of the ultimate document. The GUI generation logic 143b is also advantageous in that it generates the second graphical user interface 193b directly from the second template 136b.

Although the GUI generation logic 143a (FIGS. 3 and 4) and 143b (FIG. 8) of the present invention is embodied in software executed by general purpose hardware as discussed above, as an alternative the GUI generation logic 143a (FIGS. 3 and 4) and 143b (FIG. 8) may also be embodied in dedicated hardware or a combination of software/general purpose hardware and dedicated hardware. If embodied in dedicated hardware, the GUI generation logic 143a and 143b can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The flow charts of FIGS. 3, 4, and 8 show the architecture, functionality, and operation of an implementation of the GUI generation logic 143a and 143b. If embodied in software, each block may represent a module, segment, or portion of code that comprises one or more executable instructions to implement the specified logical function(s). If embodied in hardware, each block may represent a circuit or a number of interconnected circuits to implement the specified logical function(s). Although the flow charts of FIGS. 3, 4, and 8 show a specific order of execution, it is understood that the order of execution may differ from that which is depicted. For example, the order of execution of two or more blocks may be scrambled relative to the order shown. Also, two or more blocks shown in succession in FIGS. 3, 4, and 8 may be executed concurrently or with partial concurrence. It is understood that all such variations are within the scope of the present invention. Also, the flow charts of FIGS. 3, 4, and 8 show are relatively self-explanatory and are understood by those with ordinary skill in the art to the extent that software and/or hardware can be created by one with ordinary skill in the art to carry out the various logical functions as described herein.

Also, the GUI generation logic 143a and 143b can be embodied in any computer-readable medium for use by or in connection with an instruction execution system such as a computer/processor based system or other system that can fetch or obtain the logic from the computer-readable medium and execute the instructions contained therein. In the context of this document, a “computer-readable medium” can be any medium that can contain, store, or maintain the GUI generation logic 143a and 143b for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as floppy diskettes or hard drives, a random access memory (RAM), a read-only memory (ROM), an erasable programmable read-only memory, or a portable compact disc.

Although the invention is shown and described with respect to certain preferred embodiments, it is obvious that equivalents and modifications will occur to others skilled in the art upon the reading and understanding of the specification. The present invention includes all such equivalents and modifications, and is limited only by the scope of the claims.

I/we claim:

1. A system for generating a graphical user interface (GUI), comprising:
a processor circuit having a processor and a memory;
GUI generation logic stored on the memory and executable by the processor, the GUI generation logic comprising:
logic to generate an input field in the graphical user interface, the input field being associated with an input item in a template; and
logic to generate an input field label in the graphical user interface from an input field tag in the template, the input field tag being associated with the input item in the template.

2. The system of claim 1, wherein the GUI generation logic further comprises logic to identify the input item in the template.

3. The system of claim 1, wherein the GUI generation logic further comprises logic to identify an input item in the template that is not to be included in the graphical user interface.

4. The system of claim 1, wherein the GUI generation logic further comprises logic to identify a section in the template marked by a section tag and an ending section tag, wherein a number of the input items are nested within the section tag and the ending section tag.

5. The system of claim 4, wherein the GUI generation logic further comprises:
logic to generate a section label in the graphical user interface from the section tag in the template; and
logic to generate the input field in the graphical user interface in association with the section label.

6. The system of claim 1, where in the GUI generation logic further comprises logic to identify an alternate section in the template that includes a number of input items marked by an alternate section tag and an ending alternate section tag.

7. The system of claim 6, wherein the GUI generation logic further comprises logic to generate an alternate input field label in a graphical user interface from an alternate label attribute in the template, the alternate label attribute being associated with the input item in the template.

8. A system for generating a graphical user interface, comprising:
means for generating an input field in a graphical user interface, the input field being associated with an input item in a template; and
means for generating an input field label in a graphical user interface from an input field tag in the template, the input field tag being associated with the input item in the template.

9. The system of claim 8, further comprising means for identifying the input item in the template.

10. The system of claim 8, further comprising means for identifying an input item in the template that is not to be included in the graphical user interface.

11. The system of claim 8, further comprising means for identifying a section in the template marked by a section tag and an ending section tag, wherein a number of the input items are nested within the section tag and the ending section tag.

12. The system of claim 11, further comprising:
means for generating a section label in the graphical user interface from the section tag in the template; and
means for generating the input field in the graphical user interface in association with the section label.

13. The system of claim 8, further comprising means for identifying an alternate section in the template that includes a number of input items marked by an alternate section tag and an ending alternate section tag.

14. The system of claim 13, further comprising means for generating an alternate input field label in a graphical user interface from an alternate label attribute in the template, the alternate label attribute being associated with the input item in the template.

15. A method for generating a graphical user interface, comprising the steps of:
generating an input field in a graphical user interface in a server, the input field being associated with an input item in a template that is stored in the server; and
generating an input field label in a graphical user interface from an input field tag in the template, the input field tag being associated with the input item in the template.

16. The method of claim 15, further comprising the step of identifying the input item in the template.

17. The method of claim 15, further comprising the step of identifying an input item in the template that is not to be included in the graphical user interface.

18. The method of claim 15, further comprising the step of identifying a section in the template marked by a section tag and an ending section tag, wherein a number of the input items are nested within the section tag and the ending section tag.

19. The method of claim 18, further comprising the steps of:
generating a section label in the graphical user interface from the section tag in the template; and
generating the input field in the graphical user interface in association with the section label.

20. The method of claim 15, further comprising the step of identifying an alternate section in the template that includes a number of input items marked by an alternate section tag and an ending alternate section tag.

21. The method of claim 20, further comprising the step of generating an alternate input field label in a graphical user interface from an alternate label attribute in the template, the alternate label attribute being associated with the input item in the template.

22. A system for generating a graphical user interface (GUI), comprising:
a processor circuit having a processor and a memory;
GUI generation logic stored in the memory and executable by the processor, the GUI generation logic comprising:
logic to identify an input item with a default value in a template, the template representing a document; and
logic to generate the graphical user interface from the template that displays the document with an input field included therein, wherein the input field is associated with the input item.

23. The method of claim 22, wherein the GUI generation logic further comprises logic to include the default value of the input item within the input field for display in the document in the graphical user interface.

24. The system of claim 22, wherein the GUI generation logic further comprises logic to position the input field within the document based upon a set of location coordinates associated with the input item in the template.

25. The system of claim 22, wherein the GUI generation logic further comprises logic to write a received input value over the default value of the input item.

26. The system of claim 22, wherein the GUI generation logic further comprises logic to identify an input item in the template for which a corresponding input field is not included in the document displayed in the graphical user interface.

27. A system for generating a graphical user interface, comprising:
means for identifying an input item with a default value in a template, the template representing a document; and
means for generating the graphical user interface from the template that displays the document with an input field included therein, wherein the input field is associated with the input item.

28. The system of claim 27, further comprising means for including the default value of the input item within the input field for display in the document in the graphical user interface.

29. The system of claim 27, further comprising means for positioning the input field within the document based upon a set of location coordinates associated with the input item in the template.

30. The system of claim 27, further comprising means for writing a received input value over the default value of the input item.

31. The system of claim 27, further comprising means for identifying an input item in the template for which a corresponding input field is not included in the document displayed in the graphical user interface.

32. A method for generating a graphical user interface, comprising the steps of:
identifying an input item with a default value in a template stored in a server, the template representing a document; and
generating the graphical user interface in the server from the template that displays the document with an input field included therein, wherein the input field is associated with the input item.

33. The method of claim 32, further comprising the step of including the default value of the input item within the input field for display in the document in the graphical user interface.

34. The method of claim 32, further comprising the step of positioning the input field within the document based upon a set of location coordinates associated with the input item in the template.

35. The method of claim 32, further comprising the step of writing a received input value over the default value of the input item.

36. The method of claim 32, further comprising the step of identifying an input item for which a corresponding input field is not included in the document displayed in the graphical user interface.
